(19) United States
(12) Patent Application Publication
(10) Pub. No.: US 2009/0182617 A1
(43) Pub. Date: Jul. 16, 2009

(54) Method for Improving Customer Satisfaction

(75) Inventors: Mark E. Decker, Pflugerville, TX (US); Michael K. Turner, Austin, TX (US)

Correspondence Address: BAKER BOTTS, LLP, 910 LOUISIANA, HOUSTON, TX, 77002-4995, US

(73) Assignee: DELL PRODUCTS L.P.

(21) Appl. No.: 12/014,390

(22) Filed: Jan. 15, 2008

(51) Int. Cl. G06F 17/00

(52) U.S. Cl. 705/10; 705/7

(57) ABSTRACT

A method for optimizing a process utilized in providing a service to a customer is disclosed in which the series of steps involved in the process are first identified. Each process step is then tracked and the tracked steps are analyzed to determine if the process can be improved.

### TECHNICAL FIELD

The present invention relates generally to a business method, and, more particularly, to a method of increasing the value of services provided to customers.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

Information handing systems may be utilized in personal or business applications. In both instances, it is important for a customer in need of an information handling system to be able to conveniently order and receive the information handling systems desired. Considering the level of competition among companies providing information handling systems and related services, a company's failure to meet customer expectations can have major adverse effects on the company's prospects.

As a result, information handling system providers are always looking for ways to meet or exceed customer expectations. However, due to the large number of internal processes involved in providing a service to a customer it is desirable to provide an effective and systematic method for analyzing the processes undertaken and selecting an optimal process that would maximize customer satisfaction.

### SUMMARY

In accordance with the present disclosure, a method for increasing the value of a service provided to a customer is disclosed. The series of process steps involved in providing a service are identified and stored. Each process step involved is then tracked and analyzed and the process is optimized by eliminating redundant process steps, consolidating process steps or performing process steps faster. In one embodiment two or more optimized processes may be compared to determine which outperforms the other in terms of value delivered to a customer. In another embodiment, the optimization process is used to develop an improved method of delivering servers to customers on demand whereby information regarding a customers ordering history is used to project the customer's future needs. Servers reflecting a customer's current and future needs are then delivered to the customer providing the customer with real time service delivery on demand as the need for additional servers arises.

The method disclosed herein is advantageous in that it provides a systematic approach to improving customer satisfaction and service performance. Because the process steps involved in rendering a service are optimized, the service provider can perform with a higher efficiency and reduce its incurred costs. Moreover, a customer can benefit from the reduced costs and the faster service which in some instances such as delivery of servers, can yield on demand service thereby optimizing the value of the provided service to a customer.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a flow diagram of a series of steps for optimizing a service provided to a customer;

FIG. 2 is a flow diagram of a series of steps for delivering servers ordered by a customer;

FIG. 3 is a table of steps involved in filling a customer's orders for servers as depicted in FIG. 2;

FIG. 4 is a flow diagram of a series of steps for an optimized method of delivering servers to a customer; and

FIG. 5 is a flow diagram of a series of steps for identifying a process with superior customer value.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

An information handling system provider may provide a number of different services to a customer such as manufacturing an information handling system, shipping an information handling system, etc. It is desirable for the information handling system provider to optimize each of the services provided to a customer in order to ensure future business and expand its customer base. An optimal service is one which is available to a customer in real time. The value of a service to a customer is typically decreased when there is a delay in providing that service.

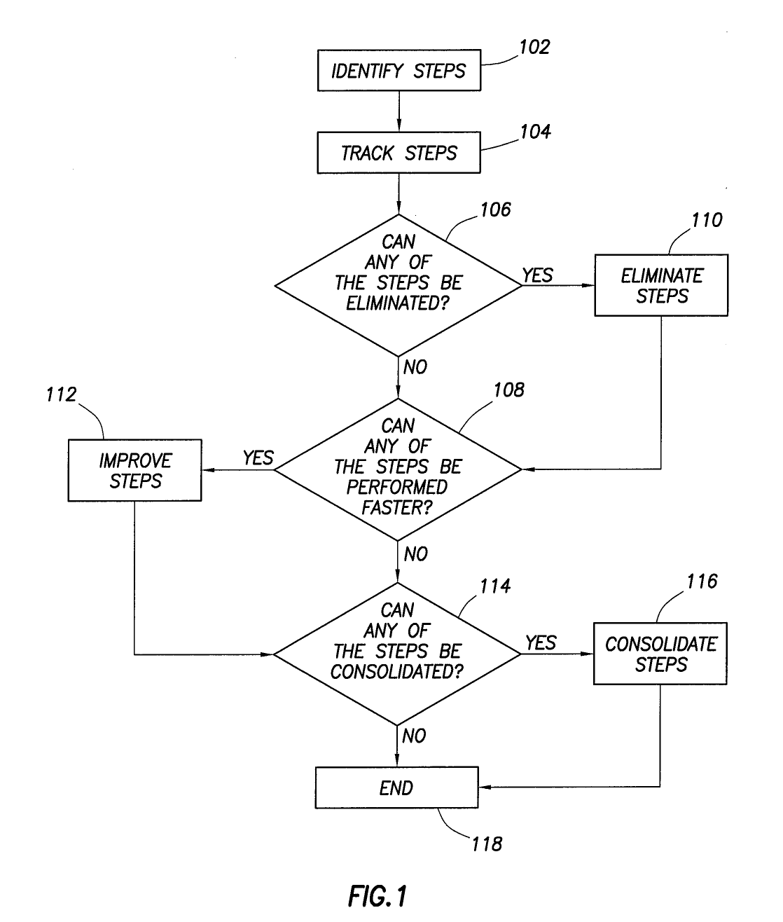

Shown in FIG. 1 is a flow diagram of a series of steps for optimizing a service provided to a customer. The steps to be carried out in order to provide a particular service to a customer are identified at step 102. In one embodiment the step information may be saved in a temporary table. Each step is then tracked at step 104. When tracking a step the user may consider factors such as, for example, the time it takes to execute the step or the amount of resources required to execute the step. Next, at step 106 it is determined whether there are any redundant steps that can be eliminated all together. If not, the process continues to step 108. If a step can be eliminated, then the step is eliminated from the table at step 110 before the process continues to step 108. At step 108, it is determined whether any of the steps can be performed faster. If it is determined that the step can be performed at a higher speed, a notation is made in the temporary table at step 112. The notation may, for example, include the manner in which the step can be performed faster. Next, at step 114 it is determined whether any of the steps may be consolidated to improve overall performance. If so, the steps are consolidated in the temporary table at step 116. The process then terminates at step 118. Once the process is terminated, the temporary table containing step information includes the optimal way of providing the particular service. Specifically, the resulting temporary table does not include redundant steps, has consolidated steps where possible, and includes notations regarding how a particular step may be performed faster.

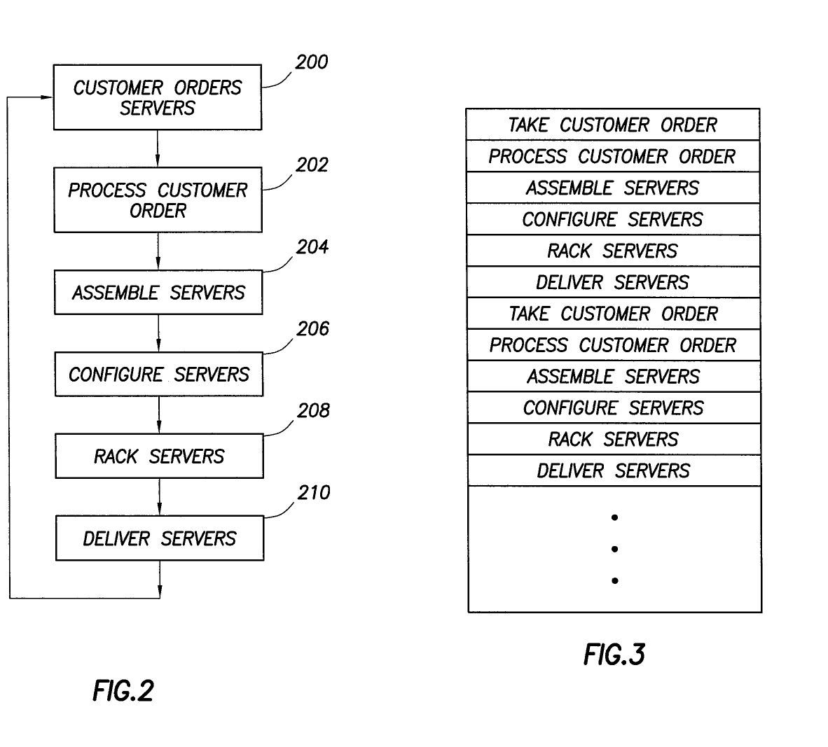

Shown in FIG. 2 is an exemplary process for delivering servers to a customer by an information handling system provider. The servers are ordered by a customer at step 200. The information handling system provider processes the order at step 202. Next, the information handling system provider must assemble the hardware for the requisite servers at step 204 and configure them at step 206. Configuring a server may involve installing the customer's requisite software components on the server. Once configured, the servers are placed in a rack at step 208 and shipped to the customer at step 210. Customers often require servers on an on-going basis. For instance, a customer may require additional servers on monthly basis. As a result, the process is often repeated several times for a particular customer over a period of time.

The process depicted in FIG. 2 may be enhanced using the method disclosed in FIG. 1. First, the steps to be carried out are identified and recorded in a temporary table in step 102. An exemplary table of the steps carried out when delivering servers to a customer over time is depicted in FIG. 3. Next, at 104, the performance of each step is tracked. For instance, the amount of time required to carry out each step or the number of personnel required to carry out a particular step may be tracked. At step 106, it is determined whether any of the steps can be eliminated. For example, for the process of providing servers to a customer as depicted in FIGS. 2 and 3, it may be determined that all the steps are necessary and none can be eliminated. Next, at step 108, it is determined whether the amount of time spent in performing each step may be reduced. For example, when providing servers to a customer, the paperwork involved in processing an order may be reduced to speed up that step. Similarly, a user may identify other steps that can be performed at a faster rate. Finally, at step 114 it is determined whether any of the steps involved can be consolidated to achieve a more efficient performance. In the example depicted in FIGS. 2 and 3, the user may take note of the repeated nature of a customers orders and use that information to consolidate the steps involved.

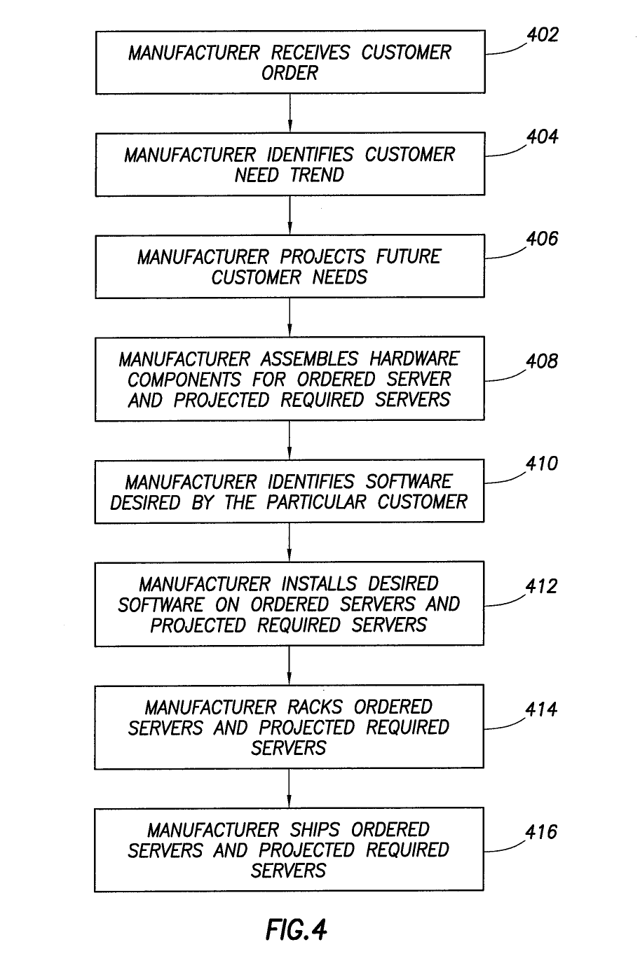

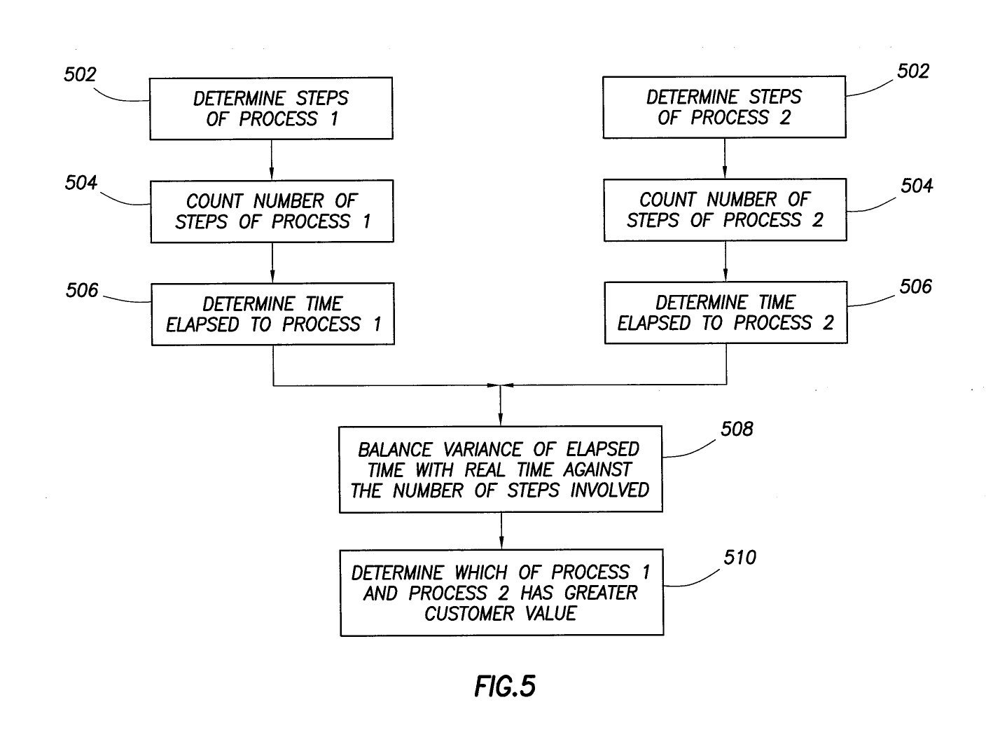

Specifically, applying the method of FIG. 1 to the process of providing servers to a customer as depicted in FIGS. 2 and 3 leads to a new and improved approach whereby servers can be delivered to a customer upon demand. The improved method of providing customers with servers on demand is depicted in FIG. 4. At step 402, a manufacturer receives a customer's order. For instance, a customer may order 48 servers. Using that customer's ordering history, the manufacturer identifies a customer need trend at step 404 and projects customer's future need for servers accordingly at step 406. For instance, if the manufacturer's database indicates that the particular customer has been ordering around 50 servers every month over that past 6 months, this information is used to project that in addition to the 48 servers ordered by the customer, the customer might need an estimated additional 100 servers over the next three month. Thus, although the current order is for 48 servers, the manufacturer will assemble the hardware components for 148 servers at step 408.

Next, at step 410, the manufacturer's database is used to determine the software to be installed on the servers. Specifically, custom software is installed on the servers based on the past software requirements of the customer as they exist in manufacturer's database. The custom software is installed on the ordered servers as well as the additional servers projected to be required by the customer in the future. In this example, the software will be installed on all 148 servers. At step 414 all the servers ordered by the customer as well as those projected to be required in the future are placed in a rack. Finally, the assembled racks are shipped to the customer at 416.

Therefore, in the present example, the customer who ordered 48 servers will receive 148 servers. The manufacturer and the customer can enter a server-on-demand agreement whereby the customer is only obligated to pay for the servers as they are put in use. Hence, in the present example, the customer will only pay for 48 servers at first. A month later, once the additional 50 servers are turned on and placed in service, the customer will pay for those. In the third month, once the remaining 50 servers are turned on, the customer will pay the manufacturer for the remaining servers. Finally, the server-on-demand agreement will include a provision whereby if the customer does not use all the servers delivered after a set period, for example three months, they will have to pay for any non-used servers at the end of that period.

The result is a satisfactory arrangement for both the manufacturer and the customer. The customer no longer needs to order a server and wait to receive the server or have to check on the status of its order. Moreover, the customer does not pay for a server until it is placed in use and hence, the overall process is virtually equivalent to the customer being able to “purchase” a server at the moment the need for a server arises. This is practically equivalent to the optimal real time service delivery. Similarly, the manufacturer can cut back its costs associated with processing customer orders, assembling, configuring and shipping servers through consolidation, while achieving improved customer satisfaction. As would be appreciated by those of ordinary skill in the art, with the benefit of this disclosure, the method depicted in FIG. 1 can be used to improve any other processes carried out by a service provider.

In another embodiment, as depicted in FIG. 5, the method of the present invention further includes a comparison of two or more processes available for performing a task to determine which provides the most value to the customers. Different factors may be considered in evaluating the value of a process to a customer. In one exemplary embodiment, the method includes a comparison of the mean time to execute for each process. The mean time to execute may be determined based on the time it takes to perform a process and the number of steps involved. First, all the steps involved in each of the processes to be compared are identified at step 502 and the number of steps involved is determined at 504. Next, the amount of time required for the completion of each process is recorded at step 506. The amount of requisite time for each process and the number of steps involved are then balanced at 508. Based on the variance between real time and the time it takes to perform each process and the number of steps involved in each process a service provider can determine the most efficient process at step 510. For instance, although one process is faster than the other, it may not be the most favorable if it involves too many steps. This is because each step poses a risk to customer satisfaction as a failure in each step can diminish the value of the service to a customer.

In one embodiment, two processes for performing a task may be first optimized using the process outlined in relation to FIG. 1. The optimized processes can then be compared using the process disclosed in FIG. 5 to determine which process provides the most value to a customer. The result will be an optimized process that can maximize customer satisfaction.

Although the present invention is disclosed in the context of information handling systems, as would be appreciated by those of ordinary skill in the art, with the benefit of this disclosure, the methods disclosed in the present invention may be used in a number of different industries to improve the value of services provided to a customer. Moreover, although the present disclosure has been described in detail, it should be understood that various changes, substitutions, and alterations can be made hereto without departing from the spirit and the scope of the invention as defined by the appended claims.

What is claimed is:

1. A method for optimizing a process for providing a service to a customer comprising:
identifying a series of process steps;
tracking the series of process steps; and
analyzing the series of process steps to determine if the process can be improved.

2. The method of claim 1, wherein analyzing the series of process steps comprises one of:
determining if any of the steps can be eliminated;
determining if any of the steps can be performed faster; or determining if any of the steps can be consolidated.

3. The method of claim 1, further comprising:
developing a first optimized process;
developing a second optimized process; and
comparing the first and the second optimized process to select a process which maximizes service value to a customer.

4. The method of claim 3, wherein comparing the first optimized process and the second optimized process comprises:
determining a number of steps involved in the first and the second optimized process;
determining the amount of time to complete the first and the second optimized process; and
balancing the number of steps and the amount of time for the first and the second optimized process.

5. The method of claim 1, wherein the service is providing a customer with an information handling system.

6. The method of claim 5, wherein the information handling system comprises a server.

7. A method for providing a service to a customer comprising:
identifying a first process for providing the service to a customer;
identifying a second process for providing the service to the customer; and
comparing the first and the second process to determine an optimal process for providing the service.

8. The method of claim 7, wherein comparing the first process and the second process comprises:
determining a number of steps involved in the first and the second process;
determining an amount of time elapsed to complete the first and the second process;
balancing the number of steps and the amount of time for the first and the second process.

9. A method of delivering an information handling system to a customer comprising:
receiving a customer order for a first number of information handling systems;
determining a second number corresponding to the customer's projected need for information handling systems; and
providing the customer with a number of information handling systems equal to the sum of the first and the second numbers.

10. The method of claim 9, further comprising maintaining a record of the customer ordering history.

11. The method of claim 10, wherein the customer ordering history comprises one of a number of information handling systems ordered by the customer or a configuration of the information handling systems ordered by the customer.

12. The method of claim 11, wherein determining the second number comprises:
retrieving the customer ordering history; and
projecting the customer's future need based on the customer ordering history.

13. The method of claim 9, wherein the information handling systems are servers.

14. The method of claim 13, wherein providing the customer with a server comprises:
assembling the server hardware components; and
configuring the server software components;

15. The method of claim 14, wherein configuring the server software components comprises:
retrieving the customer ordering history;
analyzing the customer ordering history to identify software components desired by the customer; and
configuring the server with the desired software components.
